(19) United States
(12) Patent Application Publication
(10) Pub. No.: US 2015/0064956 A1
(43) Pub. Date: Mar. 5, 2015

(54) CONNECTOR DEVICE

(71) Applicant: Samsung Electronics Co., Ltd., Gyeonggi-do (KR)

(72) Inventors: Won-Seob Kim, Seoul (KR); Jun-Hwan Lee, Gyeongsangbuk-do (KR); Myung-Keun Seo, Gyeongsangbuk-do (KR); Jung-Je Bang, Gyeongsangbuk-do (KR); Eun-Seok Hong, Gyeonggi-do (KR); Ji-Nyeon Kim, Gyeonggi-do (KR); Seung-Hyun Lee, Gyeonggi-do (KR)

(73) Assignee: Samsung Electronics Co., Ltd., Gyeonggi-do (KR)

(21) Appl. No.: 14/223,877

(22) Filed: Mar. 24, 2014

(30) Foreign Application Priority Data
Sep. 3, 2013 (KR) 10-2013-0105788

(51) Int. Cl. H01R 29/00

(52) U.S. Cl. CPC H01R 29/00
USPC 439/345

(57) ABSTRACT

A connector device includes one or more connection terminals, and a shell housing provided with a body receiving one or more connection terminals, and fixing portions formed as one piece with the body and fixed to a substrate. A standard mode typed connector device includes the connection terminals mounted to be close to an upper surface in the body. A reverse mode typed connector device includes the connection terminals mounted to be close to a bottom surface of the body. Also other embodiments of the connector device are disclosed.

### CROSS-REFERENCE TO RELATED APPLICATION AND CLAIM OF PRIORITY

The present application is related to and claims the priority under 35 U.S.C. §119(a) to Korean Patent Application No. 10-2013-0105788, which was filed in the Korean Intellectual Property Office on Sep. 3, 2013, the entire content of which is hereby incorporated by reference.

### TECHNICAL FIELD

The present disclosure relates to a connector device used for a variety of electronical devices.

### BACKGROUND

Generally, a portable electronic device refers to a device by which a user accesses various contents while carrying the device, such as a portable electronic device, an MP3 player, a Portable Multimedia Player (PMP), an electronic book and the like. Especially, the portable electronic device has various intensive functions. Such a portable electronic device has supported various kinds of wireless mobile communication services using different frequency bands while being convenient for a consumer to use, and having an elegance design and a thin thickness. The portable electronic device has a connector device such as a communication port mounted therein and connected to a plug connector in order to transmit and receive data and the like.

The connector device may be generally classified into a standard mode type connector device and a reverse mode type connector device according to an arranged direction of a connection terminal.

Generally, the connector device is standardized for compatibility with another device in connection, and may be changed in a shape of a connector or a connector device when a new standardized connector or connector device appears. Further, the number of connector terminals of a connector or a connector device satisfying the conventional standard may be changed in order to improve a data transmission rate. Accordingly, in the case that the standard is changed, a new connector device to which two or more types of standardized connectors are connectible is required in order to keep use of electronic devices in consideration of compatibility of the new standard with the conventional standard.

In the case of the connector device to which two or more types of standardized connectors are connectible, however, additional parts for hardware and mechanical compatibility are required in comparison with an exclusive connector device. Accordingly, there is a disadvantage in that an electronic device may be increased in size compared to the conventional electronic device when the new connector device is mounted in the electronic device. Further, a separate auxiliary mechanism may be provided for the new connector device in order to increase mechanical coupling rigidity suitable for changed details. At this time, additional efforts may be necessary for providing the new connector device with the auxiliary mechanism.

### SUMMARY

To address the above-discussed deficiencies, it is a primary object to provide a connector device which can receive one or more types of connection terminals, can be provided to an electronic device such as an internal circuit board through a process, and can have a wholly improved rigidity.

Further, another aspect of the present disclosure is to provide a connector device which has a minimized change in size although a length, a thickness, a width and the like thereof are increased as a plurality of connection terminals is provided, and which can prevent interference between an antenna module and a connector device.

Furthermore, still another aspect of the present disclosure is to provide a connector device in which a reinforcement cover separately provided on a shield case enclosing connection terminals is formed as one piece with the shield case in order to improve mechanical coupling rigidity suitable for changed details of the connector device, and which is capable of securing rigidity using only a case receiving and fixing the connection terminals thereto.

In addition, still another aspect of the present disclosure is to provide a connector device for restricting a movement of a plug connector and supporting the plug connector when being connected to the plug connector connected to each connection terminals provided thereof.

In accordance with an aspect of the present disclosure, a connector device is provided. The connector device includes one or more connection terminals, and a shell housing provided with a body receiving the one or more connection terminals, and fixing portions formed as one piece with the body and fixed to a substrate.

In accordance with another aspect of the present disclosure, a connector device is provided. The connector device includes a terminal body in which one or more connection terminals are mounted to be neighbored on each other, and a shell housing receiving the terminal body, wherein the shell housing includes: a body having a receiving portion in which a terminal body is located at a rear portion of the receiving portion and one or more connection terminals are located at a front portion, a fixing portion formed as one piece with the body along an outer periphery of the body and fixed to a substrate, and a guide protrusion partitioning a space for an attachment and detachment of the plug connector connected to the one or more connection terminals and fixedly supporting the plug connector in the attachment and detachment space.

In accordance with still another aspect of the present disclosure, a connector device is provided. The connector device includes one or more connection terminals, and a shell housing receiving the one or more connection terminals, wherein the shell housing includes a terminal body having a receiving portion in which one or more connection terminals are mounted, and a fixing portion formed as one piece with the body as one piece and fixed to a substrate, a guide protrusion partitioning a space for an attachment and detachment of the plug connector connected to the one or more connection terminals and fixedly supporting the plug connector in the attachment and detachment space, and a support plate extending from a surface of the body on which the guide protrusion is located and supporting the plug connector.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a cross-sectional view illustrating a reverse mode type of a connector device in which connection terminals of USB versions 2.0 and 3.0 are mounted according to various embodiments of the present disclosure;

FIG. 2A is an exploded perspective view schematically illustrating the connector device according to various embodiments of the present disclosure;

FIGS. 2B and 2C are views illustrating a plug connector which is connected to the connector device according to various embodiments of the present disclosure;

FIG. 3 is a perspective view illustrating a body of the connector device according to various embodiments of the present disclosure;

FIG. 4 is a plan view illustrating the body of the connector device according to an embodiment of the present disclosure;

FIG. 5 is a rear view illustrating a fixing portion of the connector device according to the embodiment of the present disclosure;

FIG. 6 is a cross-sectional view illustrating the connector device according to the embodiment of the present disclosure;

FIG. 7 is a view illustrating a connector device including a body with a support plate according to an embodiment of the present disclosure;

FIG. 8 is a view illustrating the connector device including the body with the support plate according to the embodiment of the present disclosure;

FIG. 9 is a view illustrating the connector device including the support plate according to an embodiment disclosure, in which a plug connector is coupled with the connector device;

FIG. 10 is a cross-sectional view illustrating a standard mode type of a connector device according to an embodiment of the present disclosure, in which the connector device is mounted on a substrate; and

FIG. 11 is a cross-sectional view illustrating the reverse mode type of the connector device according to the embodiment of the present disclosure, in which the connector device is mounted on a substrate.

### DETAILED DESCRIPTION

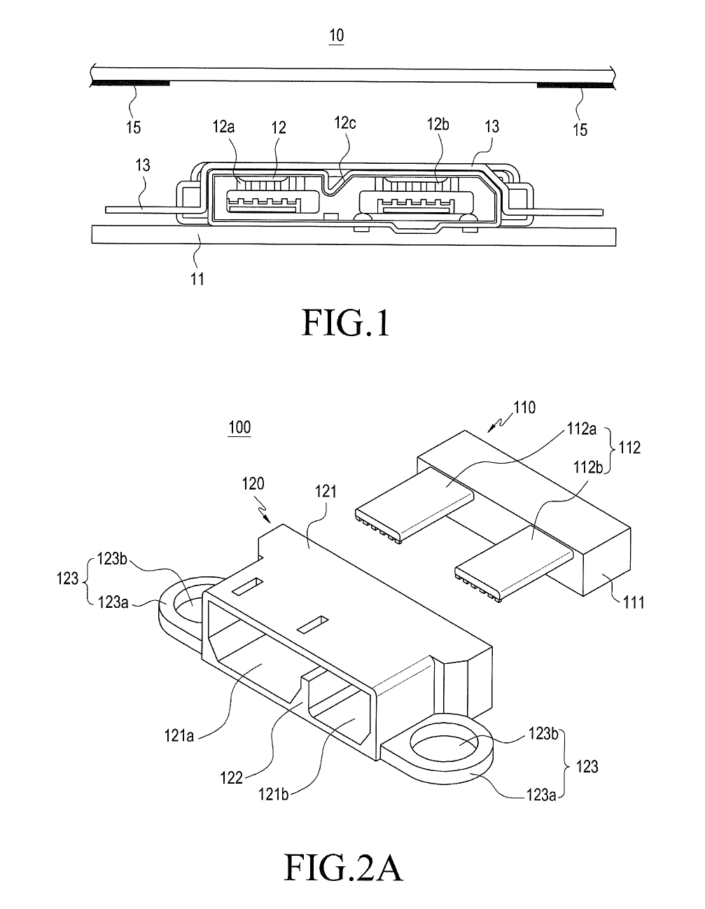

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged connector devices. Hereinafter, a connector device 100 according to various embodiments of the present disclosure will be described in detail with reference to the accompanying drawings. In the description, a thickness of lines or a size of structural elements in the drawings may be exaggeratedly shown for a convenience and definition. Further, terms to be described later are defined in consideration of functions in the present disclosure, and may be changed according to a user, an intention of an operator, or a convention. Therefore, the definitions of the terms should be determined based on contents throughout the specification.

Furthermore, in the description of the embodiments of the present disclosure, ordinal numbers such as first and second are used, but are to merely distinguish objects having the same name from one another, Orders thereof may be arbitrarily determined and the description of a preceding object will be applied to a following object.

In addition, in the description of various embodiments of the connector device, the connector device to which plug connectors of micro USB versions 2.0 and 3.0 are connectible will be described as an example. However, the connector device according to various embodiments of the present disclosure is not limited thereto, and described as an example in consideration of convenience of the description. The connector device according to various embodiments of the present disclosure may be provided with a plurality of connection terminals so that a plurality of plug connectors is selectively connected to the connection terminals according to a structure of an electronic device or a transmission rate, and accordingly the connector device which may receive the plurality of connection terminals, has reinforcement force without use of a separate reinforcement member and can be fixed to a substrate, will be described.

Further, in the description of various embodiments of the present disclosure, the terms “connector device” can be substituted with a terminology such as a socket, a jack, a connection terminal, a connector and the like, while the term “plug connector” can be replaced with a terminology such as a plug, a male (female) cable and the like.

FIG. 1 is a cross-sectional view illustrating a reverse mode type of a connector device in which connection terminals of USB versions 2.0 and 3.0 are mounted according to various embodiments of the present disclosure. Referring to FIG. 1, a connector device 10 provided with a plurality of connection terminals according to a change of connector standards provided to the electronic device and the like is provided. Recently, connectors of USB versions 2.0 and 3.0 have been provided together. Accordingly, the connectors with plural types of connection terminals have increased in length, height and width, compared with the connector device 10 having only one connection terminal. When a reinforcement cover 13 is provided on an outer surface of a shield case 12 receiving the connector device 10, particularly a connection terminal, the connector device 10 has an increased length, height and width and the electronic device has an increased space which the connector device occupies. Further, the electronic device includes at least one antenna module 15 which can be located at a lower portion of the electronic device considering a limitation in space, a radiation performance and the like. Accordingly, the antenna module 15 is actually provided at a position around the connector mounted on a lower portion of the electronic device.

The connector device 10 including one connection terminal can be spaced from a mounting position of the antenna module 15, and the reinforcement cover 15 provided on an outer surface of the shield case 12 in order to reinforce the connector device 10 causes interference with the mounting position of the antenna module 15. Further, as the connector device 10 is close to the antenna module 15, it has an effect on the radiation performance of the antenna module 15. Therefore, a structure of the electronic device has to be changed in order to prevent the interference between the reinforcement cover 13 and the antenna module 15. However, the electronic device can be increased in size or thickness due to the change in the structure of the electronic device, resulting in retrogression against an implementation of the electronic device in which portability or slimness is intended to be improved.

In the case of a standard mode typed connector device, not shown, furthermore, a connection terminal is placed on a shield case 12 and spaced far from a substrate 11. In a reverse mode typed connector device, on the other hand, a connection terminal is located under the shield case 12 and on an internal circuit substitute 11. The reverse mode type connector device has weak rigidity in comparison with the standard mode type connector device. Therefore, a thickness of an upper side of the shield case 12 or a thickness of an upper side of the reinforcement cover has to be increased in order to improve the rigidity of the connector device, so that the connector device has an increased entire height.

Further, after the shield case 12 is electrically connected to the substrate 11, the reinforcement cover 13 is provided on the shield case 12 and the connector device 10 is fixed to the substrate 11 according to a fixing process. In this case, the process of fixing the connector device 10 must be performed several times, thereby causing a manufacturing cost to increase due to an increasing of the number of processes.

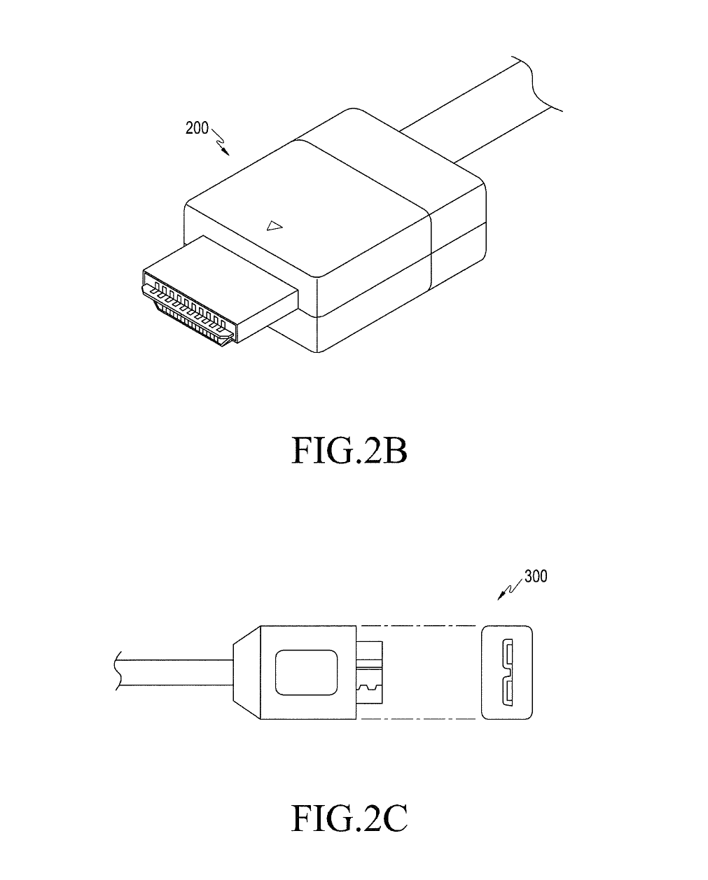

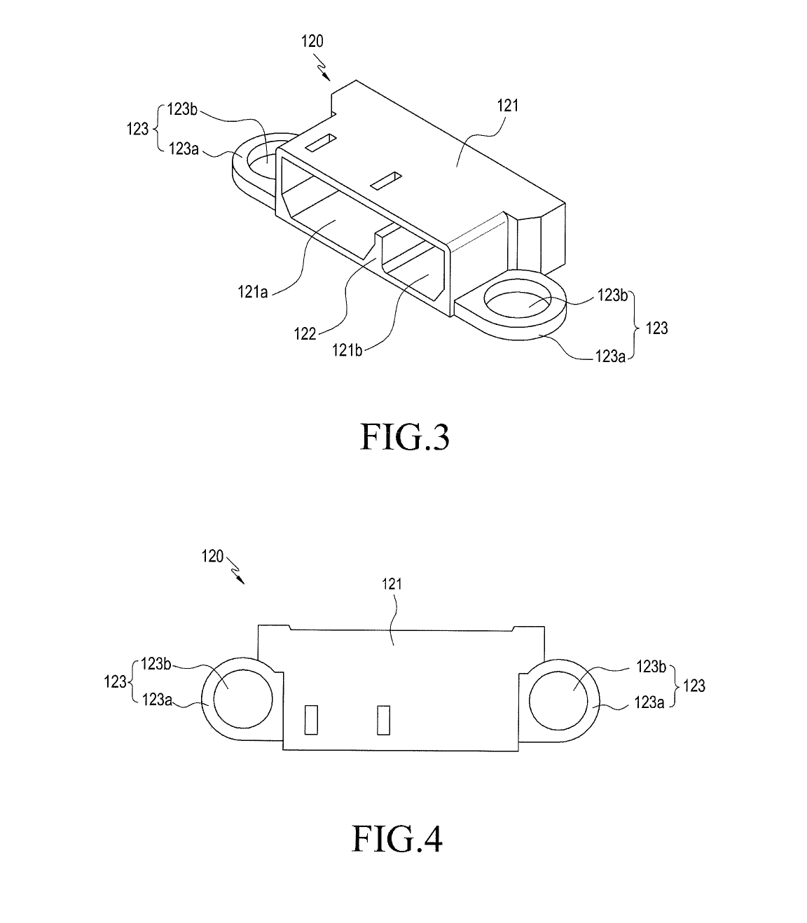

FIG. 2A is an exploded perspective view schematically illustrating the connector device according to various embodiments of the present disclosure. FIGS. 2B and 2C are views illustrating plug connectors of micro USB version 2.0 and 3.0 connectable to the connector device according to an embodiment of the present disclosure. FIG. 3 is a perspective view illustrating a body of the connector device according to various embodiments of the present disclosure. Referring to FIGS. 2A to 3, the connector device 100 according to various embodiments of the present disclosure is mounted on the substrate 130, and includes connection terminals 110 and a shell housing 120.

The connection terminals 110 are connected to a terminal body 111 to be adjacent to each other. The terminal body 111 is seated in a rear portion of a shell housing 120 described later, and the connection terminals 110 are provided at a side of the terminal body 111 to be adjacent to each other. When the terminal body 111 is seated in a rear portion of a receiving space, the connection terminals 110 are located in a front portion of the receiving space in the shell housing 120.

The connection terminals 110 can include a first connection terminal 112a mounted in a side of a body portion 121 described later and to which a first plug connector 200 is connectable, and a second connection terminal 112b mounted in another side of the body portion 121 and adjacent to the first connection terminal 112a and to which a second plug connector 300 is connectable. For example, the connection terminals 110 can include connection terminals of USB versions 2.0 and 3.0 to which the plug connector 200 of a micro USB version 2.0 and the plug connector 300 of a micro USB version 3.0 are connectable according to a standard. However, the connection terminals 110 are not limited thereto, and necessary connection terminals 112a and 112b can be provided according to a structure or use of the electronic device.

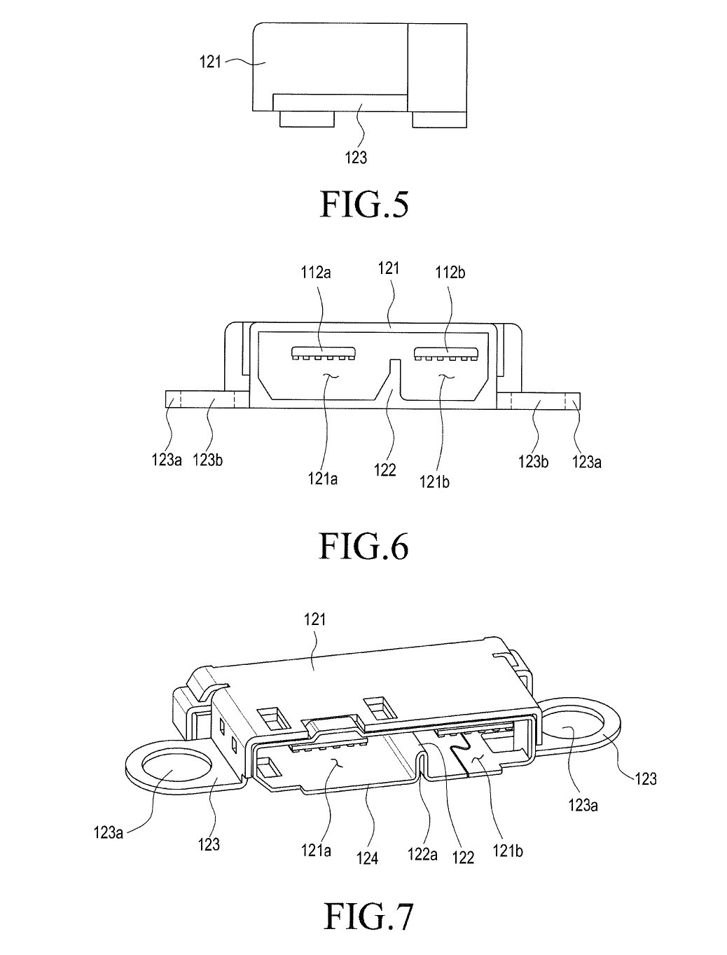

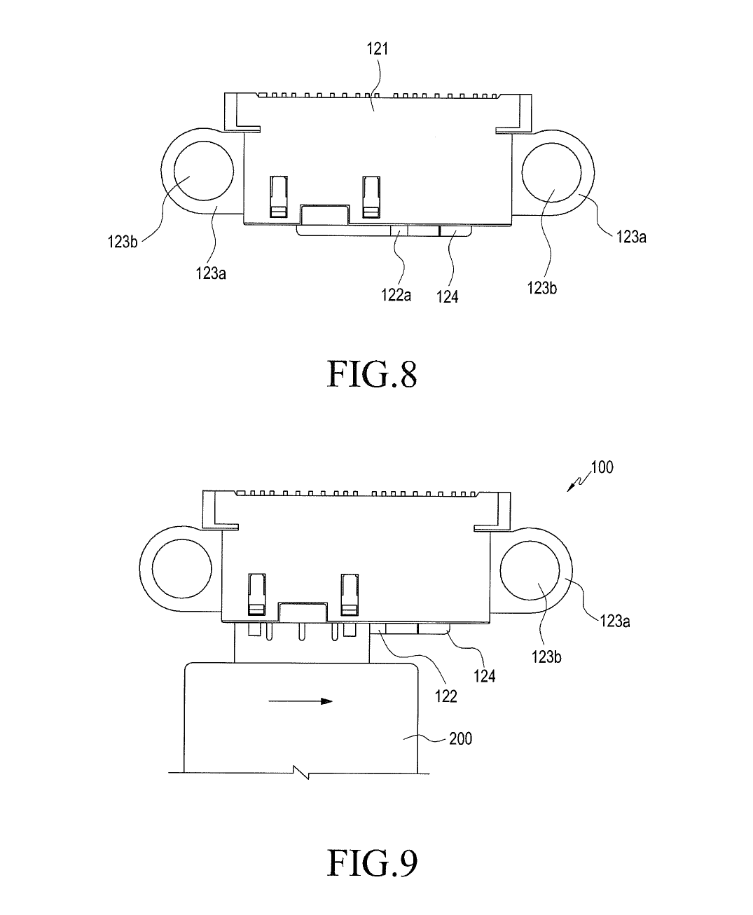

FIG. 4 is a plan view illustrating the body of the connector device according to an embodiment of the present disclosure. FIG. 5 is a rear view illustrating a fixing portion of the connector device according to the embodiment of the present disclosure. Referring to FIGS. 4 and 5, the shell housing 120 can include a body portion 121 and a fixed portion 123 formed as one piece with the body portion 121. Here, the term “formed as one piece” (or integrated) narrowly means that at least two structures are formed as one piece without use of a coupling member, and widely means that at least two structures are coupled as one piece to form a body. The shell housing 120 can be made from a conductive metal plate by pressing or the like. However, the shell housing 120 is not limited thereto, for example, a processing method or a material of the shell housing 120 is not limited thereto and the shell housing 120 can be processed by milling or the like. The fixed portion 123 can protrude in parallel with a bottom surface from an outer periphery of both sides of the body portion 121. The fixed portion 123 is configured to be inserted into a substrate 130, particularly a structure such as a boss 131 formed on the substrate 130 (see FIGS. 6 and 8). The fixed portion 123 can include a fixed plate 123a and a hole 123b. The fixed plate 123a is formed on peripheries of outer surfaces of the body 121, and in particular, protrudes from both sides in parallel with a bottom surface. The hole 123b is formed on the fixed plate 123a, and inserted and fixed to the boss 131 of the substrate 130.

FIG. 9 is a cross-sectional view illustrating the connector device according to the embodiment of the present disclosure. Referring to FIG. 9, a guide protrusion 122 is provided which fixes the plug connectors 200 and 300 to be supported in the receiving space and partitions the receiving spaces 121a and 121b in order to restrict movements of the plug connectors 200 and 300, when the plug connectors 200 and 300 are provided in the receiving spaces 121a and 121b of the body portion 121 to be connected to the connection terminals 110. When the first connection terminal 112a including the connection terminal of the USB version 2.0 and the second connection terminal 112b including the connection terminal of the USB version 3.0 are mounted on the terminal body 111 to be neighbored on each other, an inside of the body portion 121 is partitioned by the guide protrusion 122 into two spaces. A first receiving space 121a is to receive the plug connector 200 of the micro USB version 2.0, and a second receiving space 121a and 121b is to receive the plug connector 300 of the micro USB version 3.0 to which the first connection terminal 112a and the second connection terminal 112b are connectable together.

FIG. 7 is a perspective view illustrating a connector device including a body portion with the support plate according to an embodiment of the present disclosure, and FIG. 8 is a plan view illustrating the connector device including the body portion with the support plate according to the embodiment of the present disclosure. Further, FIG. 9 is a view illustrating the connector device including the support plate according to an embodiment of the present disclosure, in which a plug connector is connected to the connector device. Referring to FIGS. 7, 8 and 9, the body portion 121 can include the support plate 124.

The support plate 14 restricts the movement of each plug connector 200 or 300 provided in the first receiving space 121a and the second receiving space 121b, and fixes and supports the plug connectors 200 and 300.

The support plate 124 has a structure in that one surface of the body portion 121 on which the guide protrusion 122 is provided extends and protrudes upwardly from an identical surface to the one surface of the body portion 121. Further, the support plate 124 extends by a predetermined length from the guide protrusion 122 to a side of the body portion 121 so as to support the plug connector 200 seated in the first receiving space 121a, while extending by a predetermined length from the guide protrusion 122 to another side of the body portion 121 so as to support the plug connector 200 seated in the second receiving space 121b. Therefore, the plug connector 300 connected to the first connection terminal 121a and the plug connector 200 connected to the second connection terminal 121b can be supported and guided by the support plate 124. Separation strengths at left and right sides of the plug connectors 200 and 300 can be secured by the support plate 124, and it is possible to prevent a damage of the connector device 100, particularly the shell housing 120.

Although it is not shown, the connector device can further include a coupling unit for fixing the terminal body 111 in the state that the terminal body 111 is located in the receiving spaces 121a and 121b. The coupling unit is welded along a line of the body portion 121 folded on the terminal body 111 or the guide protrusion 122, or slit along the line of the body portion 121 folded on the guide protrusion 122, so as to fixedly couple the terminal body 111 with the body portion 121 and restrict the movement of the terminal body 111.

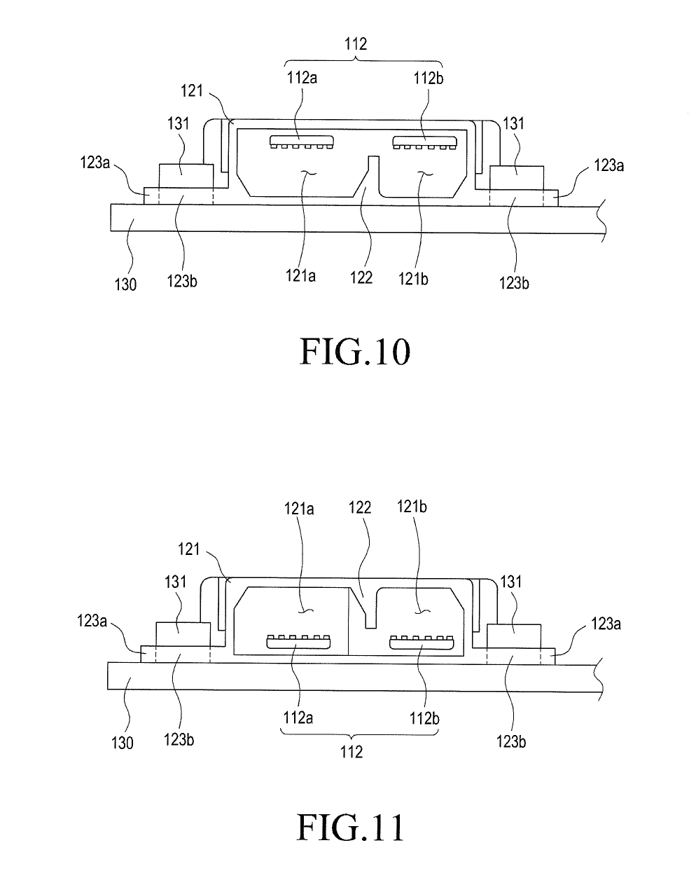

FIG. 10 is a cross-sectional view illustrating the standard mode typed connector device according to one embodiment of the present disclosure, in which the connector device is mounted on the substrate, and FIG. 11 is a cross-sectional view illustrating the reverse mode type connector device according to an embodiment of the present disclosure, in which the connector device is mounted on the substrate. Referring to FIGS. 10 and 11, the connector device 100 according to various embodiments of the present disclosure can be classified into the standard mode typed connector device and the reverse mode typed connector device based on a mounting position of the connection terminals 110.

In the standard mode typed connector device, when the connection terminals 110 are mounted in the body portion 121, the connection terminals 110 are placed to be close to a surface (hereinafter, referred to as “an upper surface”) opposite to a bottom surface of the body portion 121 by a reference of the bottom surface (refers to a surface mounted on the substrate 130) of the body portion 121, and is opposite to the bottom surface.

In the reverse mode typed connector device, when the connection terminals 110 are mounted in the body portion 121, the connection terminals 110 are placed to be close to the bottom surface of the body portion 121, so as to be opposite to the upper surface.

In the standard mode typed connector device, the guide protrusion 122 protrudes from the upper surface toward the bottom surface in the body portion, and in the reverse mode typed connector device, the guide protrusion 122 protrudes from the bottom surface toward the upper surface in the body portion 121.

Especially, in the case of the reverse mode typed connector device, the connection terminals 110 are located to be close to the bottom surface of the body portion 121. Accordingly, the shell housing 120 of the reverse mode typed connector device includes the body portion 121, the fixing unit 123 and the coupling unit, and can further include a first body portion 121 in which the connection terminals 110 are received, and a second body portion 121 formed as one piece with the first body portion 121 while enclosing the upper surface of the first body portion 121. The fixing unit 123 is formed as one piece with the second body portion 121. Accordingly, the second body portion 121 has a section in a reversed U shape, both ends of which are bent and formed to be identical to the substrate 130. The coupling unit is welded to the first body portion 121 on an outer surface of the second body portion 121, or is engaged with and coupled to the guide protrusion 122 of the first body portion 121 so that the second body portion 121 is slit.

As described above, the connection terminals are received in the shell housing fixed to the substrate so as to simultaneously reinforce and fix the connector device.

Further, because a separate reinforcement member covering the shell housing is unnecessary, the connector device can have a reduced thickness, length or width and it is possible to sufficiently secure the mounting space of the connector device provided with at least two connection terminals. In addition, it is possible to prevent the interference between the connector device and the antenna module mounted in the electronic device.

According to various embodiments of the present disclosure, the connector device can receive at least one connection terminal therein, and can be fixed to the internal circuit board through a process when it is provided for the electronic device.

Further, since the connector device can be fixed to boss halls on the substrate, it is possible to improve the whole rigidity of the connector device. The shield case is formed as one piece with the reinforcement cover to be one piece, thereby preventing the shield case and the reinforcement cover from being twisted or wrenched.

Further, although the plurality of connector devices is provided, the connector device can be minimized in size, and the interference between the connector device and the antenna module can be prevented.

Further, although the plurality of connection terminals is provided and the plug connector is connected to each connection terminal, it is possible to restrict the movement of the plug connector and to support the plug connector.

Although the connector device according to various embodiments of the present disclosure has been described in the description, it is obvious to those skilled in the art that various modifications can be carried out without departing from the scope of the present disclosure.

For example, as described above, although one or more connection terminals may be provided, and the connection terminals of the USB versions 2.0 and 3.0 and the plug connectors connected thereto are described as examples, the connection terminals may be variously modified according to the connector device necessary for the electronic device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A connector device comprising:
one or more connection terminals; and
a shell housing provided with a body to receive the one or more connection terminals, and fixing portions formed as one piece with the body, to be fixed to a substrate.

2. The connector device as claimed in claim 1, further comprising a terminal body having one end of the connection terminals fixed thereto to be neighbored on each other, the terminal body being located at a rear portion of the shell housing.

3. The connector device as claimed in claim 1, wherein each fixing portion comprises:
a fixing plate protruding along a periphery of the body; and
a hole formed in the fixing plate, to be inserted in and be fixed to a protruding boss of the substrate.

4. The connector device as claimed in claim 1, wherein the connector devices is at least one of a standard mode typed connector device in which the connection terminals are mounted to be close to an upper surface in the body, or a reverse mode typed connector device in which the connection terminals are mounted to be close to a bottom surface of the body.

5. The connector device as claimed in claim 4, wherein the standard mode typed connector device has a guide protrusion provided in the body protrudes from the upper surface toward the bottom surface in the body.

6. The connector device as claimed in claim 1, further comprising:
a support plate disposed on an upper surface of the body to maintain a shape of a guide protrusion provided in the body and extending on an identical surface to the upper surface.

7. The connector device as claimed in claim 6, wherein the support plate has a length longer than one half of a distance between the guide protrusion and both sides of the body around the guide protrusion.

8. The connector device as claimed in claim 4, wherein the reverse mode typed connector device comprises a guide protrusion provided in the body protrudes from the upper surface toward the bottom surface in the body.

9. The connector device as claimed in claim 8, further comprising:
a support plate disposed on a bottom surface of the body to maintain a shape of a guide protrusion provided in the body and extending on an identical surface to the bottom surface.

10. The connector device as claimed in claim 9, wherein the support plate has a length longer than one half of a distance between the guide protrusion and both sides of the body around the guide protrusion.

11. The connector device as claimed in claim 1, further comprising a coupler for coupling the body with a terminal body on which the connection terminals are mounted to be neighbored.

12. The connector device as claimed in claim 11, wherein the coupler is welded to an outer surface of the body to correspond to a position of the terminal body.

13. The connector device as claimed in claim 11, wherein the coupler is slit along the guide protrusion.

14. The connector device as claimed in claim 1, further comprising a support plate extending and protruding on a surface identical to that of the body at a position of the body in which a guide protrusion is provided.

15. The connector device as claimed in claim 1, wherein the one or more connection terminals comprise:
a first connection terminal mounted on a surface of the body and to which a first plug connector is connected; and
a second connection terminal neighbored on the first connection terminal or mounted on a surface of the body which includes the first connection terminal, and connected to a second plug connector along with the first connection terminal.

16. The connector device as claimed in claim 4, wherein the body of the shell housing of the reverse mode typed connector device comprises:
a first body in which the connection terminals are received;
a second body having the fixing portion along a periphery of the first body and formed as one piece with the first body while enclosing the first body; and
a coupler to fix the first body to the second body.

17. A connector device comprising:
a terminal body in which one or more connection terminals are mounted to be neighbored on each other; and
a shell housing receiving the terminal body,
wherein the shell housing includes:
a body having a receiving portion in which a terminal body is located at a rear portion of the receiving portion and one or more connection terminals are located at a front portion;
a fixing portion formed as one piece with the body along an outer periphery of the body, to be fixed to a substrate; and
a guide protrusion partitioning a space for an attachment and detachment of the plug connector connected to the one or more connection terminals, to fixedly support the plug connector in the attachment and detachment space.

18. A connector device comprising:
one or more connection terminals; and
a shell housing to receive the one or more connection terminals,
wherein the shell housing includes:
a terminal body having a receiving portion in which one or more connection terminals are mounted; and
a fixing portion formed as one piece with the body as one piece, to be fixed to a substrate;
a guide protrusion partitioning a space for an attachment and detachment of the plug connector connected to the one or more connection terminals, to fixedly support the plug connector in the attachment and detachment space; and
a support plate extending from a surface of the body on which the guide protrusion is located and supporting the plug connector.

19. The connector device as claimed in claim 18, wherein the connector device includes at least one of a standard mode typed connector device in which the connection terminals are mounted to be close to an upper surface in the body, and a reverse mode typed connector device in which the connection terminals are mounted to be close to a bottom surface of the body.

20. The connector device as claimed in claim 19, wherein the standard mode typed connector device comprises the support plate extending from the upper surface of the body to be identical to the upper surface.

21. The connector device as claimed in claim 19, wherein the standard mode typed connector device comprises the support plate extending from a bottom surface of the body to be identical to the upper surface.
